(19) United States
(12) Patent Application Publication
(10) Pub. No.: US 2007/0125560 A1
(43) Pub. Date: Jun. 7, 2007

(54) Turnlock drawbar

(75) Inventor: Kelly Silbernagel, Swift Current Saskatchewan (CA)

Correspondence Address: KATTEN MUCHIN ROSENMAN LLP, 575 MADISON AVENUE, NEW YORK, NY, 10022-2585, US

(73) Assignee: REM MANUFACTURING LTD.

(21) Appl. No.: 11/399,308

(22) Filed: Apr. 6, 2006

(30) Foreign Application Priority Data
Nov. 23, 2005 (CA) 2,527,531

(51) Int. Cl. A01B 59/06

(52) U.S. Cl. 172/439

(57) ABSTRACT

A tubular drawbar having at each end thereof a pair of spaced apart tab members integrally attached to one side of the drawbar. In an assembly position, when harrow hooks for supporting a harrowing section are initially placed onto the drawbar, the tab members are positioned on a side of the drawbar distal to that of the towing vehicle. Once the harrow hooks have been placed, the drawbar is then rotated to assume a working position, whereby each of the pair of spaced apart tab members likewise also rotate to assume a position proximal to that of the towing vehicle, thereby retaining the outermost harrow hooks securely therebetween, so that the harrowing section cannot become unhooked during use. Coupling means are also provided on a side of the drawbar, whereby the drawbar and harrowing section can be connected to a vehicle for towing.

### FIELD OF THE INVENTION

The present invention relates to a drawbar for a harrow that can be secured to a vehicle having a novel locking arrangement for securing harrow hooks thereon, and which prevents the harrow hooks from becoming unhooked from the drawbar, even during tight turns and rigorous use of the tractor or transport vehicle to which it is attached.

### DESCRIPTION OF THE PRIOR ART

Harrow type drawbar assemblies are well known. For example, some conventional type harrow drawbar assemblies, with reference to FIG. 1, utilize an elongated tubular boom section having a flat bar attached thereto, from which harrow hooks supporting a harrowing section are secured. However, such assemblies have difficulty in following ground surface contours. Furthermore, during tight turns and rigorous use of the farm or transport vehicle to which it is attached, harrow hooks can become detached from this conventional type of harrow drawbar assembly, leading to costly delays, and the aggravation associated therewith, in re-attaching the harrow hooks to the drawbar, as well as the interruption of the task at hand. As an example, harrow hooks (13) can “ride up” onto the tubular boom section (3) in such a situation, as the farm or transport vehicle continues to pull it along, and allow the flatbar (5) to clear the bottom portion (15) of the harrow hooks, thus detaching harrow hooks from the flatbar. Furthermore, interior portions of the hooks will repeatedly contact the flatbar (5) at a select few places only. Due to the curvature of the harrow hooks, only the leading corner edges of the flatbar are essentially what contacts the interior portions of the hooks, and this leads to undue stress being placed upon the harrow hooks at these specific, concentrated points, which can result in the harrow hooks becoming damaged or broken in an accelerated manner. Additionally, the manufacturing of harrow type draw bar assemblies of the type shown in FIG. 1 requires welding or otherwise securing a piece of flat bar to the tubular boom section, requiring significant labour and materials in the manufacturing process.

Accordingly, there is a need for an improved drawbar which is economically quick and easy to manufacture, and wherein harrow hooks, when placed thereon, cannot become unhooked from the drawbar, even during tight turns and rigorous use of the farm or transport vehicle to which it is attached. There is also a need for a drawbar that disperses stresses placed on the harrow hooks and allows for improved ease and quickness in replacing and maintaining any of the harrow hooks placed thereon which support a harrowing section, or the harrowing section itself if necessary, which would also provide for reduced maintenance costs associated with the drawbar. In this regard, the present invention substantially fulfills this need.

### SUMMARY OF THE INVENTION

The object of the present invention is to provide an improved drawbar which is economically quick and easy to manufacture, and wherein harrow hooks, when placed thereon, cannot readily become unhooked from the drawbar, even during tight turns and rigorous use of the farm or transport vehicle to which it is attached.

It is another object of the present invention to provide a drawbar that disperses stresses placed on the harrow hooks over a greater surface area thereof during rigorous use, thus prolonging the usefulness of the harrow hooks, and which allows for improved ease and quickness in replacing and maintaining any of the harrow hooks placed thereon which support a harrowing section, or the harrowing section itself if necessary, which would also provide for reduced maintenance costs associated with the drawbar.

According to one aspect of the present invention, there is provided a drawbar adapted to be drawn across the ground by a vehicle, the drawbar comprising (a) a tubular boom section, the tubular boom section being laterally positioned in relation to a rear of the vehicle;(b)a pair of spaced apart tab members attached at substantially each end of the boom section, the tab members being positioned on one side of the boom section distal to that of the vehicle; and (c) coupling means for coupling the boom section to the vehicle, whereby, when the drawbar is in an assembly position, during which harrow hooks for supporting a harrowing section are initially placed onto the boom section, each of the pair of tab members are positioned on the one side of the boom section distal to that of the vehicle, and, once the harrow hooks have been placed, the drawbar is then rotated to assume a working position, whereby each of the pair of spaced apart tab members likewise also respectively rotate to assume a position proximal to that of the vehicle and retain the outermost harrow hooks on the boom section securely therebetween and preventing the harrow hooks supporting the harrowing section from becoming unhooked from the drawbar during use.

A further aspect of the present invention provides for a drawbar adapted to be drawn across the ground by a vehicle, the drawbar comprising (a) an elongated tubular boom section, the tubular boom section being laterally positioned in relation to a rear of the vehicle, and for receiving and retaining thereon a plurality of harrow hooks each having an upper curved hook portion bent substantially for supporting a harrowing section; (b) a pair of spaced apart tab members attached to each end of the boom section, the tab members being positioned on one side of the boom section distal to that of the vehicle; and (c) coupling means for coupling the boom section to the vehicle, whereby, when the plurality of harrow hooks for supporting the harrowing section are initially placed onto the boom section the drawbar is in an assembly position, and, once the harrow hooks have been placed, the drawbar is then rotated to assume a working position, whereby each of the pair of spaced apart tab members on the boom section assume a position proximal to that of the vehicle, and retain an outermost harrow hook on each end of the boom section securely therebetween and prevent any of the harrow hooks for supporting the harrowing section from becoming unhooked from the drawbar during use.

A still further aspect of the present invention provides for a drawbar adapted to be drawn across the ground by a vehicle, the drawbar comprising (a) an elongated tubular boom section, the tubular boom section being laterally positioned in relation to a rear of the vehicle, and for receiving and retaining thereon a plurality of harrow hooks of S-like shape for supporting a harrowing section;(b) a pair of spaced apart tab members attached to each end of the boom section, the tab members being positioned on one side of the boom section distal to that of the vehicle; and (c) coupling means for coupling the boom section to the vehicle, the coupling means being attached to the boom section on the one side of the boom section where the pair of spaced apart tab members are positioned, whereby, when the plurality of harrow hooks for supporting the harrowing section are initially placed onto the boom section the drawbar is in an assembly position, and, once the harrow hooks have been placed, the drawbar is then rotated 180□ counterclockwise to assume a working position, whereby each of the pair of spaced apart tab members on the boom section assume a position proximal to that of the vehicle, and retain an outermost harrow hook on each end of the boom section securely therebetween and prevent any of the harrow hooks for supporting the harrowing section from becoming unhooked from the drawbar during use.

Yet another aspect of the present invention provides for a harrow adapted to be drawn across the ground by a vehicle, the harrow comprising (a) rod means, the rod means being laterally positioned in relation to a rear of the vehicle; (b) a pair of spaced apart tab members attached to each end of the rod means; (c) coupling means for connecting the rod means to the rear of the vehicle; (d) a plurality of hook means for removable attachment onto the rod means; and (e) frame means attached to and supported by the plurality of hook means, the frame means having a plurality of tines mounted thereon and depending therefrom, whereby, when the harrow is in an assembly position, during which the plurality of hook means for supporting the frame means are initially placed onto the rod means, each of the pair of tab members are positioned on the one side of the rod means distal to that of the rear of the vehicle, and, once the plurality of hook means have been placed, the harrow is then rotated to assume a working position, whereby each of the pair of spaced apart tab members on the rod means likewise also respectively rotate to assume a position proximal to that of the rear of the transport vehicle and retain the outermost ones of the plurality of hook means on the rod means securely therebetween and preventing any of the plurality of hook means supporting the frame means from becoming unhooked from the rod means during use of the harrow.

Yet another aspect of the present invention provides for a harrow adapted to be drawn across the ground by a vehicle, the harrow comprising (a) elongated rod means, the rod means being laterally positioned in relation to a rear of the vehicle; (b)a pair of spaced apart tab members attached to each end of the rod means, the tab members being positioned on one side of the rod means distal to that of a rear of the vehicle; (c) coupling means for connecting the rod means to the rear of the vehicle, the coupling means being attached to the rod means on the one side of the rod means where each of the pair of spaced apart tab members are positioned; (d) a plurality of harrow hooks for removable attachment onto the rod means, the plurality of harrow hooks each having an upper curved hook portion bent substantially; and (e) frame means attached to and supported by the plurality of harrow hooks, the frame means having a plurality of tines mounted thereon and depending therefrom, whereby, when the harrow is in an assembly position, during which the plurality of harrow hooks for supporting the frame means are initially placed onto the rod means, each of the pair of tab members are positioned on the one side of the rod means distal to that of the rear of the vehicle, and, once the plurality of harrow hooks have been placed, the harrow is then rotated 180□ counterclockwise to assume a working position, whereby each of the pair of spaced apart tab members on the rod means likewise also respectively rotate to assume a position proximal to that of the rear of the transport vehicle and retain the outermost ones of the plurality of harrow hooks on the rod means securely therebetween, wherein the outermost ones of the plurality of harrow hooks, when secured, restrict lateral movement of any of the innermost of the plurality of harrow hooks off of the rod means.

The advantage of the present invention is that it provides an improved drawbar which is economically quick and easy to manufacture for attachment to a transport or farm vehicle, wherein harrow hooks, when placed thereon, cannot become unhooked from the drawbar.

A still further advantage of the present invention is that it provides a drawbar that disperses stresses placed on the harrow hooks over a greater surface area thereof during rigorous use, thus prolonging the usefulness of the harrow hooks, and which allows for improved ease and quickness in replacing and maintaining any of the harrow hooks placed thereon which support a harrowing section, or the harrowing section itself if necessary, which would also provide for reduced maintenance costs associated with the drawbar.

### BRIEF DESCRIPTION OF THE DRAWINGS

A preferred embodiment of the present invention is described below with reference to the accompanying drawings, in which:

FIG. 1 is a perspective view illustrating a conventional type drawbar having a flatbar attached thereto, with a plurality of hooked harrow tines depending therefrom;

FIG. 2 is a perspective view of one embodiment of the turnlock drawbar of the present invention, the drawbar being shown in the assembly position, whereby the harrow hooks for supporting a harrowing section of tines are slid into position on the drawbar; and

FIG. 3 is a perspective view of an embodiment of the turnlock drawbar of the present invention, the drawbar being shown in the “locked” and working position after being rotated 180° counterclockwise.

### DESCRIPTION OF THE PREFERRED EMBODIMENT

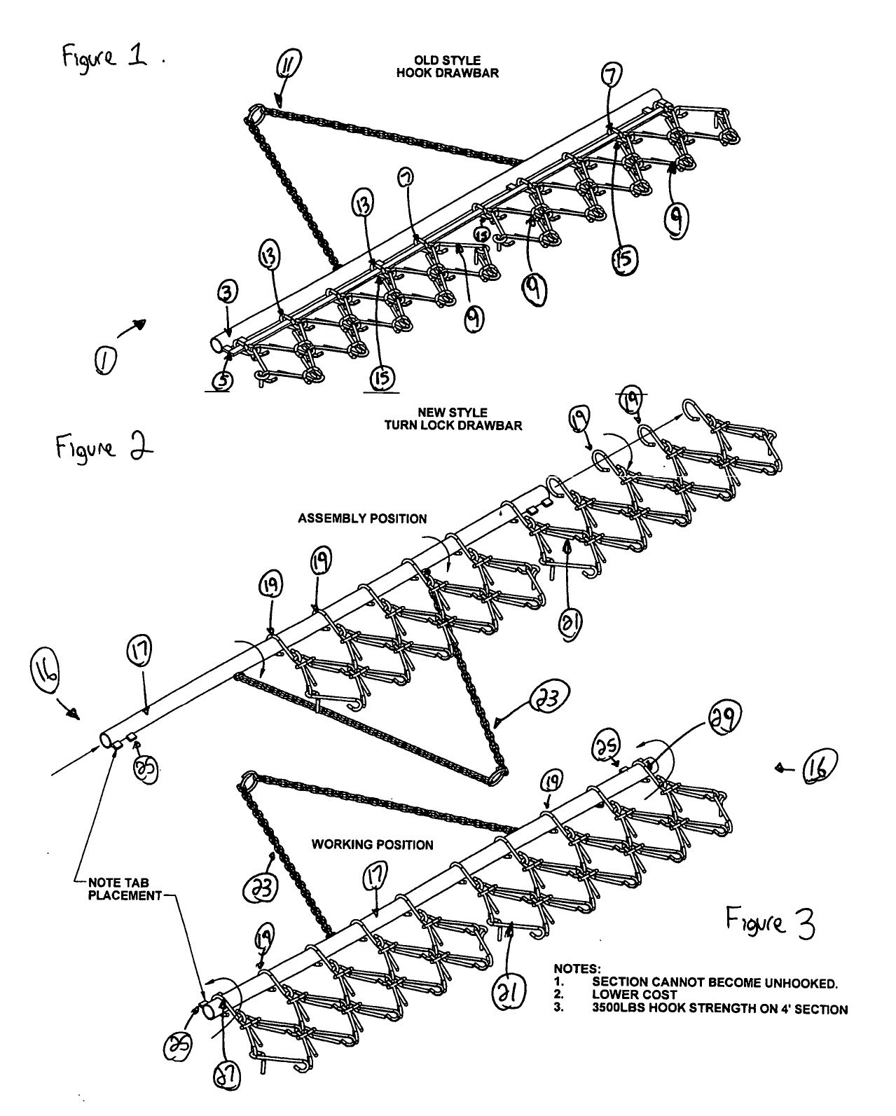

With reference to FIG. 1, there is illustrated a conventional type of drawbar (1), having a tubular boom section (3) having a flat bar (5) attached thereto, from which harrow hooks (7) supporting a harrowing section (9) are secured. The drawbar (1) can, of course, be connected to a farm (tractor) or transport vehicle (not shown) by a coupling means (11) such as a chain or other securing device. During tight turns and rigorous use of the tractor or transport vehicle to which this conventional drawbar (1) is attached the harrow hooks (7) can become detached from the flat bar (5). For example, during a tight turn of the farm or transport vehicle, or if the drawbar (1) itself encounters an obstacle on the ground surface which momentarily impedes its forward progress or causes the tubular boom section (3) to turn slightly, as the farm or transport vehicle pulls it along, it is possible that the forward portions of the harrow hooks (13) will “ride up” onto the tubular boom section (3) in such a situation, as the farm or transport vehicle continues to pull it along, and allow the flatbar (5) to clear the bottom portion (15) of the harrow hooks, thus detaching harrow hooks from the flatbar.

With reference to FIG. 2, the present invention is a drawbar (16) which preferably comprises an elongated tubular boom section (17), from which a plurality of harrow hooks (19) supporting a harrowing section (21) having tines depending therefrom can be secured to. Preferably, this drawbar will be made of metal or other type of material which can provide a sturdy, resilient construction. As can be seen in FIG. 2, the drawbar (16) of the present invention, when placed, is designed to be laterally positioned when connected to a farm or transport vehicle (not shown). The drawbar (16) can be connected to the vehicle by a coupling means (23) attached thereto such as a chain or other securing device. A pair of spaced apart tab members (25) are also attached at substantially each end of the boom section (17). Preferably, the tab members are integrally formed on the boom section (17) or welded thereto. The tab members are also preferably positioned on the same side of the boom section (17) from which the coupling means are also connected, as can be seen with reference to FIGS. 2 and 3.

In FIG. 2, the drawbar (16) is shown in an assembly position, during which the plurality of harrow hooks (19) for supporting the harrowing section (21) are initially slid onto and placed on the boom section (17), the outermost harrow hooks (27,29) on the boom section (17) being placed between each of the pair of spaced apart tab members (25). Of course, since the harrow hooks (19) used on the drawbar (16) of the present invention have an upper, resilient curved hook portion bent substantially, when the harrow hooks are placed around the boom section (17) they prevent any of the harrow hooks from becoming unhooked from the boom section (17) during use. They may slide laterally along the boom section (17) somewhat, but will eventually be restricted in their lateral movement by the placement of the outermost harrow hooks (27,29), as hereinafter described. In addition, in the assembly position of the drawbar, each of the pair of tab members (25) are positioned on the one side of the boom section (17) distal to that of the vehicle, and, once the harrow hooks (19) have been placed, the boom section (17) is then rotated, as can be seen with reference to FIG. 3, to assume a working position (whereby each of the pair of spaced apart tab members (25) likewise also respectively rotate, as the boom section to which they are attached is rotated) and assume a position proximal to that of the vehicle and retaining the outermost harrow hooks (27,29) which are placed on the boom section (17) securely therebetween, “locking” these outermost harrow hooks in place, as can be seen in FIG. 3. Although any of the other harrow hooks (19) may slide along the boom section (17) during use of the drawbar, as previously described, their lateral movement therealong will be restricted by eventual contact with the outermost harrow hooks (27,29) “locked” between the tab members (25), thus preventing any of the harrow hooks (19) supporting the harrowing section (21) from becoming unhooked from the drawbar (16) during use. In a preferred embodiment, the boom section (17) of the drawbar of the present invention is rotated 180□ counterclockwise when moving from the assembly position to assume the working position, as can be seen with reference to FIGS. 2 and 3, it being understood that various angles of rotation could be effected also, as would be apparent to a worker skilled in the art.

Preferably, the harrow hooks (19) used on the drawbar (16) of the present invention have an upper, resilient curved hook portion bent substantially (or, for additional example, an S-like shape harrow hook as in FIGS. 2 and 3), which is, of course, slid around and onto the boom section (17). The placement of the harrow hooks (19) onto the boom section (17) can be plainly seen in FIG. 2. Due to the smooth tubular construction of the boom section (17) and the curved hook portion of harrow hooks placed thereon, when the drawbar is in use the harrow hooks (19) may slide along the boom section (17) and absorb the stresses associated therewith, while still preventing any of the harrow hooks from becoming unhooked from the boom section (17) during use.

The present invention has been described herein with regard to preferred embodiments. However, it will be obvious to persons skilled in the art that a number of variations and modifications can be made without departing from the scope of the invention as described herein.

1. A drawbar adapted to be drawn across the ground by a vehicle, the drawbar comprising:
(a) a tubular boom section, the tubular boom section being laterally positioned in relation to a rear of the vehicle;
(b) a pair of spaced apart tab members attached at substantially each end of the boom section, the tab members being positioned on one side of the boom section distal to that of the vehicle; and
(c) coupling means for coupling the boom section to the vehicle, whereby, when the drawbar is in an assembly position, during which harrow hooks for supporting a harrowing section are initially placed onto the boom section, each of the pair of tab members are positioned on the one side of the boom section distal to that of the vehicle, and, once the harrow hooks have been placed, the drawbar is then rotated to assume a working position, whereby each of the pair of spaced apart tab members likewise also respectively rotate to assume a position proximal to that of the vehicle and retain the outermost harrow hooks on the boom section securely therebetween and preventing the harrow hooks supporting the harrowing section from becoming unhooked from the drawbar during use.

2. The drawbar of claim 1, wherein the drawbar is rotated counterclockwise from the assembly position to assume the working position.

3. The drawbar of claim 1, wherein the coupling means are attached to the boom section on the one side of the boom section where each of the pair of spaced apart tab members are positioned.

4. The drawbar of claim 3, wherein the boom section is an elongated boom section.

5. A drawbar adapted to be drawn across the ground by a vehicle, the drawbar comprising:
(a) an elongated tubular boom section, the tubular boom section being laterally positioned in relation to a rear of the vehicle, and for receiving and retaining thereon a plurality of harrow hooks, each having an upper curved hook portion bent substantially, for supporting a harrowing section;
(b) a pair of spaced apart tab members attached to each end of the boom section, the tab members being positioned on one side of the boom section distal to that of the vehicle; and
(c) coupling means for coupling the boom section to the vehicle, whereby, when the plurality of harrow hooks for supporting the harrowing section are initially placed onto the boom section the drawbar is in an assembly position, and, once the harrow hooks have been placed, the drawbar is then rotated to assume a working position, whereby each of the pair of spaced apart tab members on the boom section assume a position proximal to that of the vehicle, and retain an outermost harrow hook on each end of the boom section securely therebetween and prevent any of the harrow hooks for supporting the harrowing section from becoming unhooked from the drawbar during use.

6. The drawbar of claim 5, wherein the drawbar is rotated 180□ counterclockwise from the assembly position to assume the working position.

7. A harrow adapted to be drawn across the ground by a vehicle, the harrow comprising:
(a) rod means, the rod means being laterally positioned in relation to a rear of the vehicle;
(b) a pair of spaced apart tab members attached to each end of the rod means;
(c) coupling means for connecting the rod means to the rear of the vehicle;
(d) a plurality of hook means for removable attachment onto the rod means; and
(e) frame means attached to and supported by the plurality of hook means, the frame means having a plurality of tines mounted thereon and depending therefrom, whereby, when the harrow is in an assembly position, during which the plurality of hook means for supporting the frame means are initially placed onto the rod means, each of the pair of tab members are positioned on the one side of the rod means distal to that of the rear of the vehicle, and, once the plurality of hook means have been placed, the harrow is then rotated to assume a working position, whereby each of the pair of spaced apart tab members on the rod means likewise also respectively rotate to assume a position proximal to that of the rear of the transport vehicle and retain the outermost ones of the plurality of hook means on the rod means securely therebetween and preventing any of the plurality of hook means supporting the frame means from becoming unhooked from the rod means during use of the harrow.

8. The harrow of claim 7, wherein the plurality of hook means are harrow hooks of S-like shape.

9. The harrow of claim 7, wherein each of the harrow hooks further comprise an upper, resilient curved hook portion bent substantially.

10. A harrow adapted to be drawn across the ground by a vehicle, the harrow comprising:
(a) elongated rod means, the rod means being laterally positioned in relation to a rear of the vehicle;
(b) a pair of spaced apart tab members attached to each end of the rod means, the tab members being positioned on one side of the rod means distal to that of a rear of the vehicle;
(c) coupling means for connecting the rod means to the rear of the vehicle, the coupling means being attached to the rod means on the one side of the rod means where each of the pair of spaced apart tab members are positioned;
(d) a plurality of harrow hooks for removable attachment onto the rod means, the plurality of harrow hooks each having an upper curved hook portion bent substantially; and
(e) frame means attached to and supported by the plurality of harrow hooks, the frame means having a plurality of tines mounted thereon and depending therefrom, whereby, when the harrow is in an assembly position, during which the plurality of harrow hooks for supporting the frame means are initially placed onto the rod means, each of the pair of tab members are positioned on the one side of the rod means distal to that of the rear of the vehicle, and, once the plurality of harrow hooks have been placed, the harrow is then rotated 180□ counterclockwise to assume a working position, whereby each of the pair of spaced apart tab members on the rod means likewise also respectively rotate to assume a position proximal to that of the rear of the transport vehicle and retain the outermost ones of the plurality of harrow hooks on the rod means securely therebetween, wherein the outermost ones of the plurality of harrow hooks, when secured, restrict lateral movement of any of the innermost of the plurality of harrow hooks off of the rod means.
